(19) United States
(12) Patent Application Publication
(10) Pub. No.: US 2003/0013828 A1
(43) Pub. Date: Jan. 16, 2003

(54) Polyvinyl chloride dispersion resin

(76) Inventors: Kazuko Shimada, Ibaraki-shi (JP); Shinji Inoue, Settsu-shi (JP); Yukio Higashiyama, Settsu-shi (JP); Nobuki Toba, Ibaraki-shi (JP)

Correspondence Address: HOGAN & HARTSON L.L.P., 500 S. GRAND AVENUE, SUITE 1900, LOS ANGELES, CA, 90071-2611, US

(21) Appl. No.: 10/100,279

(22) Filed: Mar. 15, 2002

(30) Foreign Application Priority Data
Mar. 23, 2001 (JP) 2001-085577
Apr. 20, 2001 (JP) 2001-123023
May 22, 2001 (JP) 2001-153101

(51) Int. Cl. C08F 4/00

(52) U.S. Cl. 526/222; 526/344; 526/909; 526/217

(57) ABSTRACT

There is provided a polyvinyl chloride dispersion resin from which a product having excellent clarity and heat resistance can be obtained, and which has improved pulverization efficiency and increased recovery percentage in the production process, a plastisol composition and a plastigel composition using the same. The polyvinyl chloride dispersion resin of the present invention is obtained by polymerization using 0.1 to 5.0 parts by weight of an ammonium salt emulsifier based on 100 parts by weight of a vinyl chloride monomer, wherein the polyvinyl chloride dispersion resin has a specific surface area of 5 to 10 m²/g and comprises (A) 10 to 60% by weight of a particle having a particle diameter distribution of less than 0.5 μm and having at least one peak diameter of the distribution in the range of at least 0.1 μm to less than 0.5 μm and (B) 40 to 90% by weight of a particle having a particle diameter distribution of at least 0.5 μm and having at least one peak diameter of the distribution in the range of at least 0.5 μm to at most 1.3 μm.

### BACKGROUND OF THE INVENTION

The present invention relates to a polyvinyl chloride dispersion resin, a plastisol composition and a plastigel composition using the same. Specifically, the present invention relates to a polyvinyl chloride dispersion resin from which a product having excellent clarity and heat resistance can be obtained, a plastisol composition and a plastigel composition using the same.

Paste processing of a polyvinyl chloride dispersion resin means a process which comprises mixing a plasticizer, if necessary, a stabilizer and other components to a polyvinyl chloride dispersion resin to form the mixture into plastisol, shaping the same making use of the fluidity, followed by gellation under heat to process the same.

Examples of the processing include coating method, dipping method, spray coating method, casting method, slash molding method, rotational molding method, foaming method and the like.

Products produced by the paste processing include wall paper, floor covering, carpet tile backing, ceiling, leather, canvas, steel plates, sealant, automobile interior materials, automobile underbody coating, marking films, coating materials for insulation, table cloth and the like. Among these, clarity and heat resistance is particularly required for clear topcoat for floor covering, marking film and table cloth.

Japanese Patent Publication No. 2853387 discloses an efficient method of preparing a vinyl chloride polymer for paste processing from which a soft molded article of a polyvinyl chloride dispersion resin which has excellent clarity and whose original clarity and water resistance can be maintained even if the article is immersed in hot water. The publication discloses a method of polymerization using alkaline metal alkylsulfosuccinate salt and ammonium alkylsulfosuccinate salt together, with homogenizing the mixture adding an oil-soluble polymerization initiator. However, the method has a problem that heat resistance of the product is decreased due to the presence of alkaline metal, though clarity and water resistance are improved.

Japanese Unexamined Patent Publication No. 306234/1994 discloses a method which comprises mixing, to a latex obtained by emulsion polymerization or microsuspension polymerization using higher fatty acid ammonium salt, 0.4 to 0.8 equivalent of alkaline metal hydroxide based on higher fatty acid ammonium salt, and thereafter spray drying the same.

By adding alkaline metal hydroxide, part of the ammonium groups in higher fatty acid ammonium salt is substituted with alkaline metal, contributing to the improvement of viscosity of plastisol. However, in case of using plastisol whose viscosity is improved according to this method, there arises a problem that heat resistance of the product is decreased due to the presence of alkaline metal, though an effect of preventing fluidity and dripping can be seen when rotary screen coating is applied.

Japanese Examined Patent Publication No. 9446/1993 (Japanese Unexamined Patent Publication No. 206/1986) discloses a method in which a latex has an excellent mechanical stability with small generation amount of scale. According to this method, it is possible to prevent whitening and decrease of clarity of molded articles caused by the emulsifier in the polyvinyl chloride dispersion resin or water absorbed by the emulsifier. This publication discloses a seed emulsion polymerization method in which 0.05 to 2.0% by weight of a mixture comprising, as an emulsifier, (1) at least one selected from the group consisting of a sulfonate salt, an ether-type sulfate ester salt and a higher fatty acid salt having 8 to 22 carbon atoms and (2) a maleate copolymer salt (weight ratio of (1)/(2) being at least 1/30) based on a vinyl chloride monomer, with adjusting the pH of an aqueous medium to at least pH 6.

According to the method, whitening of molded articles and decrease of clarity can be prevented. However, there is a problem that the maleate copolymer salt (2) has lower polymerization stability than general emulsifiers for a polyvinyl chloride dispersion resin described in (1), though the maleate copolymer salt has an effect of improving mechanical stability of the latex. Besides, there is a problem that heat resistance of the product is decreased due to alkaline metal salt in the maleate copolymer salt and the general emulsifiers for a polyvinyl chloride dispersion resin.

Japanese Examined Patent Publication No. 9446/1993 also discloses “when the amount of (1) is more than 1.0% by weight, water resistance of the polymer is decreased. When the amount of (2) is more than 1.5% by weight, polymerization rate is remarkably lowered and water resistance of the polymer is decreased”. When the maleate copolymer salt is added before initiating polymerization or during polymerization, the result may be unfavorable since there is fear that polymerization rate is lowered, combined coagulation of the generated particles is caused, desirable particle diameter distribution cannot be obtained and scales may be generated.

Japanese Examined Patent Publication No. 48568/1982 discloses a method of microsuspension polymerization by using 0.01 to 0.5% by weight of a polymer containing a mono-basic or di-basic carboxylic acid/or and a salt thereof as an emulsifier in order to improve mechanical stability of the latex of a polyvinyl chloride dispersion resin. Japanese Unexamined Patent Publication No. 205/1986 discloses a method in which the latex of a polyvinyl chloride dispersion resin has an excellent mechanical stability and degassing capability. According to this method, it is possible to prevent bloom phenomenon on the surface of a molded article caused by an emulsifier in the polyvinyl chloride dispersion resin or whitening and decrease of clarity of a molded article owing to water absorption. It is proposed to use a maleate copolymer salt as an emulsifier in this publication.

However, these methods are not preferable either, since they have problems similar to that described in Japanese Examined Patent Publication No. 9446/1993, though an effect on preventing whitening and decrease of clarity of a molded article can be obtained.

### SUMMARY OF THE INVENTION

The present invention has been carried out in order to solve the above problems. An object of the present invention is to provide a polyvinyl chloride dispersion resin from which a product having excellent clarity and heat resistance can be obtained, a plastisol composition and a plastigel composition using the same.

As a result of various studies in view of solving the above problems, it has been found that a product having excellent clarity and heat resistance can be prepared from a polyvinyl chloride dispersion resin obtained by polymerization by using an ammonium salt emulsifier and adjusting the specific surface area and particle diameter distribution of the polyvinyl chloride dispersion resin to specific ranges, and the present invention has been completed.

That is, the present invention relates to a polyvinyl chloride dispersion resin which is obtained by polymerization using 0.1 to 5.0 parts by weight of at least one ammonium salt emulsifier selected from the group consisting of an ammonium carboxylate salt emulsifier, an ammonium sulfate salt emulsifier and an ammonium sulfonate salt emulsifier, based on 100 parts by weight of a vinyl chloride monomer, wherein the polyvinyl chloride dispersion resin has a specific surface area of 5 to 10 m²/g and comprises (A) 10 to 60% by weight of a particle having a particle diameter distribution of less than 0.5 μm and having at least one peak diameter of the distribution in the range of at least 0.1 μm to less than 0.5 μm and (B) 40 to 90% by weight of a particle having a particle diameter distribution of at least 0.5 μm and having at least one peak diameter of the distribution in the range of at least 0.5 μm to at most 1.3 μm.

It is preferable that the particle (B) has a peak diameter of the distribution of at least 0.6 μm to at most 0.9 μm.

It is preferable that the particle (A) has a peak diameter of the distribution of at least 0.2 μm to at most 0.4 μm.

Preferably, the amount of the component (A) is 20% by weight to 50% by weight and the amount of the component (B) is 80 to 50% by weight.

It is preferable to carry out seed emulsion polymerization as polymerization.

It is preferable to use fatty acid ammonium having 10 to 20 carbon atoms as the ammonium salt emulsifier.

Preferably, the ammonium emulsifier is at least one selected from the group consisting of a compound represented by the formula (I):

R¹O(CH₂CH₂O)ₙR²COONH₄ (I)

wherein R¹ is a monovalent hydrocarbon group having 8 to 30 carbon atoms, R² is a divalent hydrocarbon group having 1 to 30 carbon atoms and n is an integer of 1 to 30 and a compound represented by the formula (II):

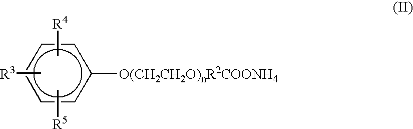

wherein each of R³, R⁴ and R⁵ is a hydrogen atom or a monovalent hydrocarbon group having 1 to 30 carbon atoms, R² is a divalent hydrocarbon group having 1 to 30 carbon atoms and n is an integer of 1 to 30.

Preferably, the ammonium emulsifier is at least one selected from the group consisting of a compound represented by the formula (III):

R¹O(CH₂CH₂O)ₙSO₃NH₄ (III)

wherein R¹ is a monovalent hydrocarbon group having 8 to 30 carbon atoms and n is an integer of 1 to 30 and a compound represented by the formula (IV):

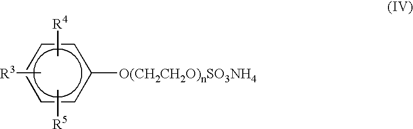

wherein each of R³, R⁴ and R⁵ is a hydrogen atom or a monovalent hydrocarbon group having 1 to 30 carbon atoms and n is an integer of 1 to 30.

It is preferable that the polyvinyl chloride dispersion resin is obtained by polymerization further using 0.005 to 1.0 part by weight of a polymeric suspending agent based on 100 parts by weight of the vinyl chloride monomer.

It is preferable to add the polymeric suspending agent to a latex of the polyvinyl chloride dispersion resin after polymerization.

The polymeric suspending agent is preferably at least one selected from the group consisting of a vinyl polymer, a vinyl copolymer and an ammonium salt thereof.

It is preferable to use poly(vinyl alcohol) as the polymeric suspending agent.

It is preferable to use a cellulose derivative as the polymeric suspending agent.

The polymeric suspending agent is preferably at least one selected from the group consisting of a carboxylic acid polymer, a carboxylic acid copolymer and an ammonium salt thereof.

The polymeric suspending agent is preferably at least one selected from the group consisting of maleic anhydride polymer, maleic anhydride copolymer and an ammonium salt thereof.

The polymeric suspending agent is preferably at least one selected from the group consisting of a copolymer comprising maleic anhydride and styrene, and an ammonium salt thereof.

The polymeric suspending agent is preferably at least one selected from the group consisting of a sodium salt and potassium salt of a vinyl polymer, a vinyl copolymer, a carboxylic acid polymer, a carboxylic acid copolymer, a maleic anhydride polymer, a maleic anhydride copolymer, a copolymer comprising maleic anhydride and styrene, wherein the amount of polymeric suspending agent is 0.005 to 0.3 part by weight based on 100 parts by weight of a vinyl chloride monomer.

The present invention also relates to a plastisol composition comprising the polyvinyl chloride dispersion resin.

The present invention also relates to a plastigel composition comprising the polyvinyl chloride dispersion resin.

### DETAILED DESCRIPTION

The polyvinyl chloride dispersion resin of the present invention suitable for paste processing is obtained by (1) emulsion polymerization or seed emulsion polymerization of only vinyl chloride monomers or a mixture comprising vinyl chloride monomers and monomers copolymerizable therewith (hereinafter referred to as vinyl chloride monomers together) in an aqueous medium by using an ammonium salt emulsifier and an aqueous polymerization initiator; or by (2) microsuspension polymerization after adding an ammonium salt emulsifier and an oil-soluble polymerization initiator to the vinyl chloride monomers and homogenizing the same in an aqueous medium, wherein other emulsifiers and dispersing assistants such as s higher alcohol and higher fatty acid can be used if necessary in addition to the ammonium salt emulsifier, and thereafter spray-drying the latex of the polyvinyl chloride dispersion resin (homogeneous aqueous dispersion solution) after polymerization. In polymerization to obtain a polyvinyl chloride dispersion resin, 80 to 95% of the vinyl chloride monomers added is polymerized to form a resin, and remaining unreacted monomers are removed. Spray drying may be carried out after mixing the latex obtained in polymerization (1) and the latex obtained in polymerization (2). If necessary, the resin after spray drying may be pulverized.

Since dehydration or filtration is not carried out at the time of drying in general, raw materials such as emulsifiers remain in the resin. In case of preparing a polyvinyl chloride dispersion resin, part of basic particles coagulates and aggregates to form secondary coagula at spray drying. In the step of pulverization, the secondary coagula is pulverized to improve dispersibility of the resin at plastisol forming and prevent generation of grain (fish eye) on a product made of plastisol. In addition, the polyvinyl chloride dispersion resin may be prepared according to a method of producing granular resin without pulverization as described in Japanese Examined Patent Publication No. 55831/1994 and Japanese Examined Patent Publication No. 72169/1994.

The polyvinyl chloride dispersion resins mentioned above have a basic particle diameter of 0.001 to 10 μm which is smaller than that of general polyvinyl chloride resins and therefore have excellent dispersability to plasticizers, and are suitable for paste processing.

In the microsuspension polymerization, particle diameter of vinyl chloride monomer droplet is controlled by the condition of homogenization. The larger the pressure difference between the inhalation port and the discharge port of homogenization apparatus is, the smaller the particle diameter of the particle to be obtained is. Examples of generally-used apparatus for homogenization include mechanical dispersion apparatus such as a one-step or multi-step high pressure homogenizer, a colloid mill, a one-step or multi-step centrifugal pump and a pipeline mixer. These may be used alone or in combination of two or more.

In emulsion polymerization, a desirable particle diameter distribution can be achieved by adjusting the amount of the emulsifier which is added at initial stage and continuously added during polymerization. The larger the amount of the emulsifier which is added at initial stage is, the smaller the particle diameter of the resin particle to be obtained is. Seed emulsion polymerization is carried out using the resin particle obtained at the first step emulsion polymerization. In seed emulsion polymerization, the resin particle obtained at the first step emulsion polymerization enlarges. In this way, seed emulsion polymerization is preferable from the viewpoint that desirable particle diameter distribution can be easily obtained.

Examples of other monomers copolymerizable with vinyl chloride are, for instant, an olefin such as ethylene, propylene or butene, a vinyl ester of a carboxylic acid such as vinyl acetate, vinyl propionate or vinyl stearate, a vinyl ether having an alkyl group such as methyl vinyl ether, ethyl vinyl ether, octyl vinyl ether or lauryl vinyl ether, a halogenated vinylidene compound such as vinylidene chloride, an unsaturated carboxylic acid and an acid anhydride thereof such as acrylic acid, methacrylic acid, fumaric acid, maleic acid, itaconic acid, maleic anhydride or itaconic anhydride, an unsaturated carboxylate ester such as methyl acrylate, ethyl acrylate, monomethyl maleate, dimethyl maleate or butylbenzyl maleate, an aromatic vinyl compound such as styrene, a-methylstyrene or divinyl benzene, an unsaturated nitrile compound such as acrylonitrile, a crosslinking monomer such as diallyl phthalate, and other vinyl monomers. These monomers may be used alone or in combination of two or more.

It is preferable that the amount of other monomers copolymerizable with vinyl chloride is at most 50% by weight based on the vinyl chloride monomer. When the amount is more than 50% by weight, polymerization becomes unstable and the paste processing becomes inferior because polyvinyl chloride dispersion resin obtained has poor dispersibility to plasticizer.

In general, a polyvinyl chloride dispersion resin is prepared by using an emulsifier comprising an alkaline metal salt (such as a sodium salt or a potassium salt) of a fatty acid compound, a sulfonate compound, a sulfosuccinate compound and the like. However, heat resistance of a product is decreased due to the alkaline metal salt contained in the emulsifier. On the other hand, in case of using an emulsifier comprising an ammonium salt of the above compound (ammonium salt emulsifier), decrease of heat resistance due to the emulsifier is prevented. Accordingly, the ammonium salt emulsifier is used in the present invention.

The amount of the ammonium salt emulsifier is 0.1 to 5 parts by weight, preferably 0.2 to 2 parts by weight, more preferably 0.3 to 1 part by weight based on 100 parts by weight of a vinyl chloride monomer. When the amount of the ammonium salt emulsifier is less than 0.1 part by weight, polymerization becomes unstable. When the amount is more than 5 parts by weight, it is not practical since production cost is increased in unfavorable comparison with the effect of adding the emulsifier.

The ammonium salt emulsifier may be added to the aqueous medium before polymerization to obtain polyvinyl chloride dispersion resin or may be continuously added during polymerization. Further, the ammonium salt emulsifier may be added to the latex after polymerization if necessary, in order to improve mechanical stability of the polymerization latex.

As mentioned above, 80 to 95% of the vinyl chloride monomers used for polymerization to obtain a polyvinyl chloride dispersion resin is formed into a resin and the remaining unreacted monomers are removed. Therefore, in case of polymerization using 1 part of an ammonium salt emulsifier based on 100 parts by weight of a vinyl chloride monomer at a polymerization conversion ratio of 80%, the content of the ammonium salt emulsifier amounts to 1.25 parts by weight of a polyvinyl chloride dispersion resin.

Examples of the ammonium salt emulsifier are an ammonium carboxylate salt emulsifier, an ammonium sulfate salt emulsifier, and an ammonium sulfonate salt emulsifier. These can be used alone or in combination of two or more. The ammonium salt emulsifiers are preferable from the viewpoint of polymerization stability and heat resistance.

Examples of the ammonium carboxylate salt emulsifier are ammonium salt of saturated fatty acid having 8 to 30 carbon atoms such as caprylic acid, pelargonic acid, capric acid, undecylic acid, lauric acid, tridecylic acid, myristic acid, pentadecylic acid, palmitic acid, heptadecylic acid, stearic acid, nonadecanoic acid or arachic acid; ammonium salt of unsaturated fatty acid having 8 to 30 carbon atoms such as undecylenic acid, oleic acid, elaidic acid, linoleic acid, linolenic acid or stearolic acid; ammonium salt of fatty acid having a substituent group and 8 to 30 carbon atoms such as hydroxylauric acid, dihydroxylauric acid, hydroxystearic acid or dihydroxystearic acid; ammonium salt of dicarboxylic acid such as adipic acid, pimelic acid, suberic acid, azelaic acid or sebacic acid; ammonium salt of aromatic carboxylic acid having 6 to 30 carbon atoms such as benzoic acid, toluic acid, phenylacetic acid, phenylpropionic acid or phenyllauric acid, and the like. Examples of the ammonium carboxylate salt further include a compound represented by the formula (I):

R¹O(CH₂CH₂O)ₙR²COONH₄ (I)

wherein R¹ is a monovalent hydrocarbon group having 8 to 30 carbon atoms, preferably an alkyl group having 8 to 20 carbon atoms, R² is a divalent hydrocarbon group having 1 to 30 carbon atoms, preferably an alkylene group having 1 to 16 carbon atoms or polymethylene group and n is an integer of 1 to 30

and a compound represented by the formula (II):

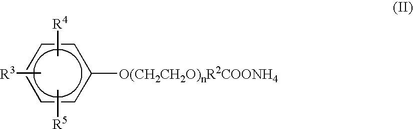

wherein each of R³, R⁴ and R⁵ is a hydrogen atom or a monovalent hydrocarbon group having 1 to 30 carbon atoms, preferably a hydrogen atom or an alkyl group having 1 to 16 carbon atoms, R² is a divalent hydrocarbon group having 1 to 30 carbon atoms, preferably an alkylene group having 1 to 16 carbon atoms or polymethylene group and n is an integer of 1 to 30. These can be used alone or in combination of two or more.

Examples of the compound represented by the formula (I) are ammonium polyoxyethylene lauryl ether acetate, ammonium polyoxyethylene lauryl ether propionate, ammonium polyoxyethylene lauryl ether laurate, ammonium polyoxyethylene nonyl ether acetate, ammonium polyoxyethylene oleyl ether acetate, and the like.

Also, example of the compound represented by the above general equation (II) is an ammmonium carboxylate having polyoxyethylene group such as ammonium polyoxyethylene phenyl ether acetate, ammonium polyoxyethylene phenyl ether propionate, ammonium polyoxyethylene octylphenyl ether acetate, ammonium polyoxyethylene dioctylphenyl ether acetate, ammonium polyoxyethylene trioctylphenyl ether acetate, ammonium polyoxyethylene nonylphenyl ether acetate, ammonium polyoxyethylene dinonylphenyl ether acetate, ammonium polyoxyethylene trinonylphenyl ether acetate or ammonium polyoxyethylene octylphenyl ether propionate.

Among the ammonium carboxylate salt emulsifiers, ammonium salts of fatty acid having 10 to 20 carbon atoms, especially, ammonium salts of capric acid, undecylic acid, lauric acid, tridecylic acid, myristic acid, pentadecylic acid, palmitic acid are preferable from the viewpoint that a product having excellent polymerization stability and heat resistance can be obtained. In the same way, the compounds represented by the formula (I) and the compounds represented by the formula (II) are preferable from the viewpoint that a product having excellent polymerization stability and heat resistance can be obtained. These can be used alone or in combination of two or more.

Examples of the ammonium sulfate salt emulsifiers are the compound represented by the formula (III):

R¹O(CH₂CH₂O)ₙSO₃NH₄ (III)

wherein R¹ is a monovalent hydrocarbon group having 8 to 30 carbon atoms, preferably an alkyl group having 8 to 20 carbon atoms and n is an integer of 1 to 30, and the compound represented by the formula (IV):

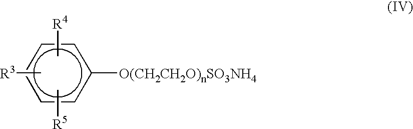

wherein each of R³, R⁴ and R⁵ is a hydrogen atom or a monovalent hydrocarbon group having 1 to 30 carbon atoms, preferably a hydrogen atom or an alkyl group having 1 to 16 carbon atoms and n is an integer of 1 to 30. These can be used alone or in combination of two or more.

Examples of the compound represented by the equation (III) are ammonium polyoxyethylene decyl ether sulfate, ammonium polyoxyethylene lauryl ether sulfate, ammonium polyoxyethylene oleyl ether sulfate, and the like.

Also, examples of the compound represented by the above general equation (IV) are ammonium sulfate salt emulsifiers having a polyoxyethylene group such as ammonium polyoxyethylene phenyl ether sulfate, ammonium polyoxyethylene octylphenyl ether sulfate, ammonium polyoxyethylene dioctylphenyl ether sulfate, ammonium polyoxyethylene trioctylphenyl ether sulfate, ammonium polyoxyethylene nonylphenyl ether sulfate, ammonium polyoxyethylene dinonylphenyl ether sulfate and ammonium polyoxyethylene trinonylphenyl ether sulfate. Also, examples of ammonium sulfate salt emulsifier having no polyoxyethylene group are an ammonium alkyl sulfate having 8 to 30 carbon atoms such as ammonium decyl sulfate, ammonium lauryl sulfate or ammonium myristyl sulfate, and an ammonium salt of natural fat and oil sulfuric acid such as castor oil sulfuric acid (Turkey red oil), coconut oil sulfuric acid or rape oil sulfuric acid, or the like.

The above ammmonium sulfonate salt emulsifier are ammonium salts of alkylbenzenesulfonic acid, a-olefin sulfonic acid, alkanesulfonic acid, and the like. These are preferable from the viewpoint of polymerization stability and heat resistance. These can be used alone or in combination of two or more.

In the present invention, known nonionic emulsifiers, anionic emulsifiers of alkaline metal salt type, polyethylene glycol and the like may be used together with the ammonium salt emulsifier for the purpose of achieving mechanical stability of polymerization and polymerization latex, and achieving low viscosity of plastisol by using the polyvinyl chloride dispersion resin. The above emulsifiers may be added to an aqueous medium before polymerization to obtain polyvinyl chloride dispersion resin or may be continuously added during polymerization. Additionally, the emulsifier may also be added to the latex after polymerization.

Generally, the nonionic emulsifiers do not contain metal salt and therefore have small influence on heat resistance.

Examples of the nonionic emulsifier include polyoxyethylene alkyl ether, polyoxyethylene alkylphenyl ether, polyoxyethylene alkenyl ether, polyoxyethylene derivatives, glycerin fatty acid ester, sorbitan fatty acid ester, polyoxyethylene sorbitan fatty acid ester, polyoxyethylene sorbitol fatty acid ester, polyoxyethylene fatty acid ester, silicone emulsifiers, a copolymer of polyethylene glycol and polypropylene glycol, polyethylene glycol derivatives, and the like. These may be used alone or in combination of two or more.

The amount of the nonionic emulsifier is not particularly limited, but preferably at most 3 parts by weight, more preferably at most 0.3 part by weight, most preferably at most 0.1 part by weight based on 100 parts by weight of a vinyl chloride monomer from the viewpoint of heat resistance.

Examples of the anionic emulsifier comprising an alkaline metal salt (such as a sodium salt, potassium salt or the like) include the salt of fatty acid compound, sulfuric acid compound, sulfonic acid compound, sulfosuccinic acid compound or phosphoric acid compound, and the like. These may be used alone or in combination of two or more.

The amount of the anionic emulsifier comprising an alkaline metal salt is preferably at most 0.3 part by weight, more preferably at most 0.2 part by weight, most preferably at most 0.1 part by weight based on 100 parts by weight of a vinyl chloride monomer from the viewpoint of small influence on heat resistance.

In the present invention, a dispersing assistant may be used in addition to the emulsifiers and the like in order to achieve mechanical stability of polymerization and the polymerization latex.

The dispersing assistant is often added continuously before or during polymerization to obtain a polyvinyl chloride dispersion resin, but may be added to the latex after polymerization.

Examples of the dispersing assistant include a higher alcohol such as lauryl alcohol, myristyl alcohol, cetyl alcohol or stearyl alcohol, and a higher fatty acid such as lauric acid, myristic acid, palmitic acid or stearic acid. These may be used alone or in combination of two or more.

The polyvinyl chloride dispersion resin of the present invention is obtained by emulsion polymerization, seed emulsion polymerization or microsuspension polymerization of the vinyl chloride monomers by using the above ammonium salt emulsifier, and if necessary, other emulsifiers and a dispersing assistant.

Examples of the aqueous polymerization initiator used in the emulsion polymerization or the seed emulsion polymerization are ammonium persulfate, potassium persulfate, sodium persulfate, hydrogen peroxide, and the like. If necessary, a reducing agent such as sodium sulfite, sodium thiosulfate, sodium formaldehyde sulfoxylate (Rongalite), ascorbic acid or sodium ascorbate, is used in combination use thereof.

Examples of the oil-soluble polymerization initiator used in the microsuspension polymerization are, for instance, organic peroxide compounds, e.g., a diacyl peroxide such as dilauroyl peroxide or di-3,5,5-trimethylhexanoyl peroxide, a peroxydicarbonate such as diisopropyl peroxydicarbonate or di-2-ethylhexyl peroxydicarbonate, and a peroxyester such as t-butyl peroxypivalate or t-butyl peroxyneodecanoate; and an azo compound such as 2,2′-azobisisobutyronitrile, 2,2′-azobis(2,4-dimethylvaleronitrile) or 2,2′-azobis(4-methoxy-2,4-dimethylvaleronitrile). These can be used alone or in combination of two or more.

The polyvinyl chloride dispersion resin of the present invention comprises a latex containing 0.1 to 5 parts by weight of an ammonium salt emulsifier based on 100 parts by weight of a vinyl chloride monomer. It is important to adjust the specific surface area and the particle diameter distribution of the polyvinyl chloride dispersion resin to a specific range.

The specific surface area of the polyvinyl chloride dispersion resin is 5 to 10 m²/g, preferably 6 m²/g to 9 m²/g. When the specific surface area is less than 5 m²/g, clarity is decreased. When it is more than 10 m²/g, viscosity of plastisol is increased.

The polyvinyl chloride dispersion resin comprises (A) 10 to 60% by weight of a particle having a particle diameter distribution of less than 0.5 μm and having at least one peak diameter of the distribution in the range of at least 0.1 μm to less than 0.5 μm and (B) 40 to 90% by weight of a particle having a particle diameter distribution of at least 0.5 μm and having at least one peak diameter of the distribution in the range of at least 0.5 μm to at most 1.3 μm. Each of the component (A) and the component (B) may have at least two peaks.

When the peak diameter of the particle (A) is smaller than 0.1 μm, viscosity of plastisol is increased. When the peak diameter of the particle (B) is larger than 1.3 μm, clarity of plastigel composition is lowered. It is preferable that the peak diameter of the particle (A) is at least 0.2 μm to at most 0.4 μm and the peak diameter of the particle (B) is at least 0.6 μm to at most 0.9 μm since fluidity of plastisol composition is increased and clarity of plastigel composition is improved.

The amount of the particle (A) ranges from 10% by weight to 60% by weight. When the amount of the particle (A) is less than 10% by weight, clarity of plastigel composition is decreased. When the amount is more than 60% by weight, viscosity of plastisol is increased. The amount of the particle (B) ranges from 40% by weight to 90% by weight. When the amount of the particle (B) is more than 90%, clarity of plastigel composition is decreased. When the amount is less than 40%, viscosity of plastisol is increased. It is preferable that the amount of the particle (A) is from 20 to 50% by weight and the amount of the particle (B) is from 50 to 80% by weight since fluidity of plastisol composition is increased and clarity of plastigel composition is improved.

The specific surface area of the polyvinyl chloride dispersion resin is measured by Flowsorb II2300 (made by Micromeritics Instrument Corporation) according to single point surface area measurement based on BET equation. Further, the particle diameter distribution is determined using the centrifugal sedimentation method based on the Stokes' law from the component ratio of the particle (A) having a diameter distribution of less than 0.5 μm to the particle (B) having a diameter distribution of at least 0.5 μm. The peak diameter of the particle (A) is measured by using NICOMP MODEL 370 (made by PACIFIC SCIENTIFIC HIAC/ROYCO Co., Ltd.), while the peak diameter of the particle (B) is measured by using Coulter Multisizer II (made by Coulter Electronics Inc.).

For the propose of improving fluidity of plastisol, a polyvinyl chloride blending resin may also be used in preparing the polyvinyl chloride dispersion resin of the present invention, which is suitable for paste processing.

In general, the polyvinyl chloride blending resin has a particle diameter of 10 to 100 μm, and is blended in an amount of at most 50% by weight based on the polyvinyl chloride dispersion resin. When the amount is more than 50% by weight, the paste processing becomes inferior because of poor dispersibility to plasticizer. The polyvinyl chloride blending resin is obtained by suspension polymerization of vinyl chloride monomers in an aqueous medium containing a polymeric suspending agent and the like, an oil-soluble polymerization initiator being added thereto, dehydrating slurry after polymerization by using a centrifugal dehydrator, and carrying out flash drying, fluidized drying and the like.

In the present invention, a polymeric suspending agent is further added to the latex of the polyvinyl chloride dispersion resin in order to improve pulverization efficiency of the polyvinyl chloride dispersion resin to be prepared. For example, the polyvinyl chloride dispersion resin obtained by spray drying of the latex of the polyvinyl chloride dispersion resin is pulverized if necessary, recovery percentage of the resin is increased in the pulverizing process by adding the polymeric suspending agent. As a result, pulverization products can be obtained as efficiently as granulation products without pulverization.

For example, improvement effect on pulverization efficiency is small and heat resistance of the product is decreased in case of adding, to the latex after polymerization, about 0.4 to 0.8 equivalent of an alkaline metal hydroxide such as sodium hydroxide or potassium hydroxide based on the used ammonium salt emulsifier as described in Japanese Unexamined Patent Publication No. 306234/1994.

As described in Japanese Patent Publication No. 2853387, there is some case where pulverization efficiency is improved by adding, to the latex after polymerization, an emulsifier comprising an alkaline metal salt (such as a sodium salt or potassium salt) of a sulfosuccinate compound, a fatty acid compound or a sulfonate compound. In this case, it is necessary to add at least 0.3 part by weight of the alkaline metal salt emulsifier based on 100 parts by weight of vinyl chloride monomers to achieve the effect. On the other hand, when the alkaline metal salt emulsifier is added in an amount of more than 0.3 part by weight, heat resistance of the product is deteriorated.

It is not preferable either to add an antistatic agent such as quaternary ammonium salts or imidazolium betaine since heat resistance is remarkably deteriorated in many cases.

The amount of polymeric suspending agent is preferably 0.005 to 1.0 part by weight, more preferably 0.005 to 0.3 part by weight, most preferably 0.01 to 0.2 part by weight based on 100 parts by weight of a vinyl chloride monomer. In this case, it is possible to improve pulverization efficiency with maintaining heat resistance of the product made of the polyvinyl chloride dispersion resin. In case of adding a sodium salt compound or a potassium salt compound as the polymeric suspending agent, the amount is preferably 0.005 to 0.3 part by weight based on 100 parts by weight of a vinyl chloride monomer.

As mentioned above, in polymerization to obtain a polyvinyl chloride dispersion resin, 80 to 95% of the vinyl chloride monomers used is formed into a resin and the remaining unreacted monomers are removed. Therefore, when 0.3 part of a polymeric suspending agent is added based on 100 parts by weight of a vinyl chloride monomer at a polymerization conversion ratio of 80%, the content of polymeric suspending agent amounts to 0.375 parts by weight of a polyvinyl chloride dispersion resin.

When the amount of the polymeric suspending agent is less than 0.005 part by weight, the above improvement effect is insufficient. When the amount is more than 1.0 part by weight, there is a fear of harmful effect on heat resistance.

Most of the polymeric suspending agents can improve pulverization efficiency in an amount smaller than that of the alkaline metal emulsifiers or the antistatic agent. Generally, sufficient effect can be achieved by adding the polymeric suspending agent in an amount of about 0.2 part by weight.

The polymeric suspending agent may be added to the aqueous medium before polymerization to obtain a polyvinyl chloride dispersion resin or may be continuously added during polymerization. Further, the polymeric suspending agent may be added to the latex after polymerization. Among them, it is most preferable to add the polymeric suspending agent to the latex after polymerization. Addition of the polymeric suspending agent after polymerization brings about increase in the amount of the polymeric suspending agent on the surface of polyvinyl chloride dispersion resin particles, and more remarkable effect on improvement of pulverization efficiency can be seen. In case of adding the polymeric suspending agent before or during polymerization, the polymeric suspending agent is incorporated into the generated particles, and therefore, it is necessary to increase the amount of addition in order to achieve an effect similar to that in case of the addition after polymerization. In addition, there is a fear that composite coagulation of the generated particles is caused to produce scales.

Examples of the polymeric suspending agent include cellulose derivatives, proteins, a vinyl polymer, a vinyl copolymer, ammonium salt thereof, sodium salt thereof or potassium salt thereof, poly(vinyl alcohol), a carboxylic acid polymer, a carboxylic acid copolymer, ammonium salt thereof, sodium salt thereof, potassium salt thereof, a maleic anhydride polymer, a maleic anhydride copolymer, ammonium salt thereof, sodium salt thereof, potassium salt thereof, and the like. These may be used alone or in combination of two or more.

Examples of the above cellulose derivatives are methyl cellulose, ethyl cellulose, carboxymethyl cellulose, hydroxyethylmethyl cellulose, hydroxypropylmethyl cellulose, or the like.

Examples of the above proteins are casein, gelatin, and the like.

Examples of the above vinyl polymer or vinyl copolymer are poly(vinyl acetal), poly(vinyl alcohol), poly(vinyl isobutyl ether), poly(vinyl ether), poly(vinyl pyrrolidone), poly(vinyl butyral), styrene polymers and copolymers and the like. These vinyl polymer or vinyl copolymer may be at least one selected from the group consisting of ammonium salt thereof, sodium salt thereof and potassium salt thereof. Among these, poly(vinyl alcohol) is preferable from the viewpoint that improvement effect on pulverization efficiency is large with maintaining heat resistance of the product made of the vinyl chloride dispersion resin. As to poly(vinyl alcohol), any of a complete saponification type, intermediate saponification type, partial saponification type or low saponification type may be used, but the water-soluble partial saponification type is preferable.

Examples of the carboxylic acid polymer and the carboxylic acid copolymer include a polymer and a copolymer of maleic acid, itaconic acid, maleic anhydride, itaconic anhydride, vinylbenzoic acid and vinylacetic acid, and the like. These carboxylic acid polymer and carboxylic acid copolymer may be at least one selected from the group consisting of ammonium salt thereof, sodium salt thereof and potassium salt thereof. Among these, a maleic anhydride copolymer is preferable from the viewpoint that improvement effect on pulverization efficiency is large with maintaining heat resistance.

Examples of the maleic anhydride copolymer are a copolymer of maleic anhydride and a vinyl compound, a copolymer of maleic anhydride and an ethylene compound. Examples of the vinyl compound used for the copolymer are styrene, divinylbenzene, vinylanisole, vinylcyclohexane, methyl vinyl ether, and the like. Also, examples of the ethylene compound used in the above copolymer are isobutylene, diisobutylene, isoprene, hexene, octene, butadiene, and the like. These maleic anhydride copolymer may be at least one selected from the group consisting of ammonium salt thereof, sodium salt thereof and potassium salt thereof. Among these, a copolymer of maleic anhydride and styrene is preferable from the viewpoint that improvement effect on pulverization efficiency is large with maintaining heat resistance. The copolymer of maleic anhydride and styrene may be at least one selected from the group consisting of an ammonium salt thereof, a sodium salt thereof and a potassium salt thereof.

To the thus-obtained polyvinyl chloride dispersion resin is added 30 to 200 parts by weight, preferably 40 to 100 parts by weight of a plasticizer based on 100 parts by weight of the polyvinyl chloride dispersion resin. The mixture is mixed into plastisol, shaped with making use of fluidity, followed by gellation under heat to fabricate the same. If necessary, a stabilizer, a filler, a reinforcing agent, a diluent, a viscosity reducing agent, an antioxidant, an ultraviolet light absorber, a blowing agent, a flame retardant, an antistatic agent, a lubricant, a pigment, a surface treating agent, a thixotropic agent, an adhesion imparting agent, mildewproofing agent and the like may be added in addition to the plasticizer.

There is no particular limitation for the plasticizer, but useful example thereof include, as a primary plasticizer, phthalic acid ester plasticizers such as di-2-ethylhexyl phthalate, dinormaloctyl phthalate, dibutyl phthalate, diisononyl phthalate and butyl benzyl phthalate; phosphoric ester plasticizers such as tricresyl phosphate or tri-2-ethylhexyl phosphate; adipic acid ester plasticizers such as di-2-ethylhexyl adipate; sebacic acid ester plasticizers such as di-2-ethylhexyl sebacate; azelaic acid ester plasticizers such as di-2-ethylhexyl azelate; adipic acid ester plasticizer such as di-2-ethylhexyl adipate; trimellitic acid ester plasticizers such as tri-2-ethylhexyl trimellitate; polyester plasticizers; benzoic ester plasticizers such as di-2-ethylhexyl benzoate, diethylene glycol dibenzoate or 2,2,4-trimethyl-1,3-pentanediol isobutylate benzoate; citric acid ester plasticizers such as acetyl tributyl citrate, and the like. These may be used alone or in combination of two or more. Also, secondary plasticizers such as glycollic acid ester plasticizers, chlorinated paraffin plasticizers, chlorinated fatty acid ester plasticizers, epoxy plasticizer and texanol isobutylate, may be used in combination use thereof. These secondary plasticizers may also be used alone or in combination of two or more.

Paste processing of a polyvinyl chloride dispersion resin means a process which comprises mixing a plasticizer, if necessary, a stabilizer and other components to a polyvinyl chloride dispersion resin to form the mixture into plastisol, shaping the same making use of the fluidity, followed by gellation under heat to process the same.

The thus-obtained plastigel composition is used for providing a product suitable for wall paper, floor covering, carpet tile backing, ceiling, leather, canvas, steel plates, sealant, automobile interior materials, automobile underbody coating, marking films, table cloth, dolls, gloves, coating materials for waterproof, coating materials for insulation, medical supplies, cap seal, food sample, and for other various purposes. In particular, the polyvinyl chloride dispersion resin of the present invention is suitably used for clear topcoat for floor covering, marking film, table cloth and the like.

### EXAMPLE

Hereinafter the present invention is explained in more detail by means of the following Examples, but the present invention is not limited thereto. “Part” and “%” in Examples mean “part by weight” and “% by weight”, respectively, unless otherwise specified.

Specific surface area and particle diameter distribution were measured according to the following method and evaluation of properties of the resin was carried out as follows.

(1) Specific Surface Area:

According to single point surface area measurement based on BET equation, specific surface area was measured by using Flowsorb 112300 (made by Micromeritics Instrument Corporation).

(2) Distribution of Particle Diameter Using the centrifugal sedimentation method based on the Stokes' law, component ratio of the particle (A) having a diameter distribution of less than 0.5 μm to the particle (B) having a diameter distribution of at least 0.5 μm was determined. The peak diameter of the particle (A) is measured by using NICOMP MODEL 370 (made by PACIFIC SCIENTIFIC HIAC/ROYCO Co., Ltd.), while the peak diameter of the particle (B) is measured by using Coulter Multisizer II (made by Coulter Electronics Inc.).

(3) Pulverization Efficiency

A resin in an amount of 1 kg was spray-dried by using a spray dryer (made by Mitsubishi Kakoki Kaisha) at an inhalation port temperature of 135° C. and a discharge port temperature of 52° C. The resin was pulverized by using Bantam mill (type AP-B made by Hosokawa Micron Corporation) to determine recovery percentage of the resin.

Recovery percentage of resin=resin weight after pulverization/resin weight before pulverization (1 kg)×100

(4) Viscosity of Plastisol

To 100 parts by weight of the polyvinyl chloride dispersion resin after pulverization was added 57 parts of DINP (diisononyl phthalate), 3 parts of a barium-zinc stabilizer and 3 parts of epoxidized soybean oil. The mixture was mixed by hand until the mixture became homogeneous. Thereafter, by using an Ishikawa mixer, the mixture was mixed at room temperature under vacuum for 20 minutes to prepare plastisol.

The obtained plastisol was kept in a thermostat adjusted to 30° C., and viscosity of the plastisol was measured by using a BM type viscometer (made by TOKIMEC Co., Ltd.) with a rotor 4 under a condition of a rotor speed of 6 rpm.

(5) Evaluation of Clarity

The above plastisol was coated on a glass plate in a thickness of 250 μm, and heated for 3 minutes at 215° C. in a Geer oven to prepare a plastigel sheet. Haze of the sheet was measured by using HAZE METER, MODEL TC-HIII (made by Tokyo Denshoku Kogyo Co. Ltd.). As the evaluation of clarity, a haze value of at most 3.0 was defined as “passed” while a haze value of more than 3.0 was defined as “not passed”.

(6) Heat Resistance

The plastisol prepared for measuring viscosity was coated on a glass plate in a thickness of 250 μm, and heated for 3 minutes at 215° C. or for 8 minutes at 215° C. in a Geer oven to prepare a plastigel sheet.

Color of the obtained plastigel sheet was measured by using COLOR AND COLOR DIFFERENCE METER, MODEL Z-1001DP (made by Nippon Denshoku Co. Ltd.).

Heating time was extended at 215° C. to measure the time for the sheet to become black.

As the evaluation of heat resistance, it was defined as “passed” when the b value in case of heating at 215° C. for 3 minutes was at most 2.0, the b value in case of heating at 215° C. for 8 minutes was at most 5.0 and the blackening time was at least 20 minutes. It was defined as “not passed” when at least one of the criteria was not satisfied.

### Preparation Example 1

A stainless pressure vessel with a stirrer was charged with 150 parts of ion exchange water, 0.5 part of ammonium laurate, 0.3 part of lauryl alcohol and 0.05 part of 2,2-azobis(2,4-dimethylvaleronitrile), and deaeration was carried out. Then, 100 parts of a vinyl chloride monomer was introduced and the mixture was homogenized in a homogenizer under a pressure difference between the inhalation port and the discharge port of 30 kg/cm² (2.94 MPa). Thereafter, polymerization was carried out with heating to 50° C. and unreacted monomers were removed when polymerization pressure dropped to complete polymerization. In this way, the polymerization latex described in Table 1 was prepared.

### Preparation Example 2

Polymerization was carried out in the same manner as in Preparation Example 1 except for using 0.5 part of sodium lauryl sulfate instead of ammonium laurate to obtain the polymerization latex described in Table 1.

### Preparation Example 3

Polymerization was carried out in the same manner as in Preparation Example 1 except for adjusting the pressure difference between the inhalation port and the discharge port of the homogenizer to 20 kg/cm² (1.96 MPa) to obtain the polymerization latex described in Table 1.

TABLE 1

| | | | |
|---|---|---|---|
| (Suspension | Prep. | Prep. | Prep. |
| polymerization) | Ex. 1 | Ex. 2 | Ex. 3 |

Initial charge

| | | | | |
|---|---|---|---|---|
| Vinyl chloride monomer | (part) | 100 | 100 | 100 |
| Water | (part) | 150 | 150 | 150 |
| Ammonium laurate | (part) | 0.5 | — | 0.5 |
| Sodium lauryl sulfate | (part) | — | 0.5 | — |
| Lauryl alcohol | (part) | 0.3 | 0.3 | 0.3 |
| 2,2′-azobis (2,4- | (part) | 0.05 | 005 | 0.05 |
| dimethylvaleronitrile) | | | | |
| Homogenization | (kg/cm²) | 30 | 30 | 20 |
| Polymerization temperature | (° C.) | 50 | 50 | 50 |
| Polymerization conversion | (%) | 90 | 92 | 92 |
| (A) Less than 0.5 μm | (%) | 8 | 7 | 7 |
| (B) At least 0.5 μm | (%) | 92 | 93 | 93 |
| Peak diameter of (A) | (μm) | — | — | — |
| Peak diameter of (B) | (μm) | 0.85 | 0.90 | 1.40 |

### Preparation Example 4

A stainless pressure vessel with a stirrer was charged with 150 parts of ion exchange water, 0.03 part of ammonium polyoxyethylene dinonylphenyl ether sulfate, 0.03 part of sodium formaldehyde sulfoxylate (Rongalite), 0.0003 part of ferrous sulfate and 0.003 part of hydrochloric acid, and deaeration was carried out. Then, 100 parts of a vinyl chloride monomer was introduced. With stirring, the mixture was heated to 50° C. and 0.01 part of hydrogen peroxide as purity content and 0.27 part of ammonium polyoxyethylene dinonylphenyl ether sulfate were continuously added during polymerization. When polymerization pressure dropped, unreacted monomers were removed to complete polymerization. The polymerization latex described in Table 2 was obtained.

### Preparation Examples 5 to 7

Polymerization was carried out in the same manner as in Preparation Example 4 except for changing each of the initial amounts and the amounts for continuous addition of ammonium polyoxyethylene dinonylphenyl ether sulfate to obtain the polymerization latex described in Table 2.

TABLE 2

| (Preparation of | | | | | |
|---|---|---|---|---|---|
| seed by emulsion | | Prep. | Prep. | Prep. | Prep. |
| polymerization) | | Ex. 4 | Ex. 5 | Ex. 6 | Ex. 7 |
| Initial charge | | | | | |
| Vinyl chloride | (part) | 100 | 100 | 100 | 100 |
| monomer | | | | | |
| Water | (part) | 150 | 150 | 150 | 150 |
| Ammonium | (part) | 0.03 | 0.01 | 0.005 | 0.003 |
| polyoxyethylene | | | | | |
| dinonylphenyl | | | | | |
| ether sulfate | | | | | |
| Rongalite | (part) | 0.03 | 0.03 | 0.03 | 0.03 |
| Ferrous sulfate | (part) | 0.0003 | 0.0003 | 0.0003 | 0.0003 |
| Hydrochloric acid | (part) | 0.003 | 0.003 | 0.003 | 0.003 |
| Continuous | | | | | |
| addition | | | | | |
| Hydrogen | (part) | 0.01 | 0.01 | 0.01 | 0.01 |
| peroxide | | | | | |
| Ammonium | (part) | 0.27 | 0.29 | 0.295 | 0.297 |
| polyoxyethylene | | | | | |
| dinonylphenyl | | | | | |
| ether sulfate | | | | | |
| Polymerization | (° C.) | 50 | 50 | 50 | 50 |
| temperature | | | | | |
| Polymerization | (%) | 90 | 90 | 92 | 91 |
| conversion | | | | | |
| (A) Less than 0.5 | (%) | 98 | 95 | 88 | 55 |
| μm | | | | | |
| (B) At least 0.5 | (%) | 2 | 5 | 12 | 45 |
| μm | | | | | |
| Peak diameter of | (μm) | 0.30 | 0.35 | 0.40 | 0.48 |
| (A) | | | | | |
| Peak diameter of | (μm) | — | — | — | — |
| (B) | | | | | |

### Preparation Example 8

A stainless pressure vessel with a stirrer was charged with 150 parts of ion exchange water, 2 part as solid content of the seed latex having a peak diameter of 0.30 μm obtained in Preparation Example 4, 0.02 part of ammonium myristate, 0.03 part of sodium sulfite and 0.0003 part of copper sulfate, and deaeration was carried out. Then, 100 parts of a vinyl chloride monomer was introduced. With stirring, the mixture was heated to 50° C. and 0.01 part of ammonium persulfate and 0.48 part of ammonium myristate were continuously added thereto during polymerization. When polymerization pressure dropped, unreacted monomers were removed to complete polymerization. In this way, the polymerization latex described in Table 3 was prepared.

### Preparation Examples 9 to 11

Polymerization was carried out in the same manner as in Preparation Example 8 except for changing kinds and amounts of the seed to obtain the polymerization latex described in Table 3.

TABLE 3

| (Seed emulsion | | Prep. | Prep. | Prep. | Prep. |
|---|---|---|---|---|---|
| polymerization) | | Ex. 8 | Ex. 9 | Ex. 10 | Ex. 11 |
| Initial charge | | | | | |
| Preparation | | Prep. | Prep. | Prep. | Prep. |
| Example of used | | Ex. 4 | Ex. 5 | Ex. 6 | Ex. 7 |
| seed | | | | | |
| Peak diameter of | (μm) | 0.30 | 0.35 | 0.40 | 0.48 |
| seed | | | | | |
| Amount of | (part) | 2 | 3 | 4 | 7 |
| charged seed | | | | | |
| Vinyl chloride | (part) | 100 | 100 | 100 | 100 |
| monomer | | | | | |
| Water | (part) | 150 | 150 | 150 | 150 |
| Ammonium | (part) | 0.02 | 0.02 | 0.02 | 0.02 |
| myristate | | | | | |
| Sodium sulfite | (part) | 0.03 | 0.03 | 0.03 | 0.03 |
| Copper sulfate | (part) | 0.0003 | 0.0003 | 0.0003 | 0.0003 |
| Continuous | | | | | |
| addition | | | | | |
| Ammonium | (part) | 0.01 | 0.01 | 0.01 | 0.01 |
| persulfate | | | | | |
| Ammonium | (part) | 0.48 | 0.48 | 0.48 | 0.48 |
| myristate | | | | | |
| Polymerization | (° C.) | 50 | 50 | 50 | 50 |
| temperature | | | | | |
| Polymerization | (%) | 92 | 90 | 93 | 89 |
| conversion | | | | | |
| (A) Less than 0.5 | (%) | 22 | 30 | 41 | 39 |
| μm | | | | | |
| (B) At least 0.5 | (%) | 78 | 70 | 59 | 61 |
| μm | | | | | |
| Peak diameter of | (μm) | 0.30 | 0.32 | 0.30 | 0.35 |
| (A) | | | | | |
| Peak diameter of | (μm) | 0.70 | 0.88 | 1.10 | 1.50 |
| (B) | | | | | |

### Preparation Examples 12 to 15

Polymerization was carried out in the same manner as in Preparation Example 8 except for changing kinds of the emulsifier to obtain the polymerization latex described in Table 4.

TABLE 4

| (Seed emulsion | | Prep. | Prep. | Prep. | Prep. |
|---|---|---|---|---|---|
| polymerization) | | Ex. 12 | Ex. 13 | Ex. 14 | Ex. 15 |
| Initial charge | | | | | |
| Preparation | | Prep. | Prep. | Prep. | Prep. |
| Example of used | | Ex. 4 | Ex. 4 | Ex. 4 | Ex. 4 |
| seed | | | | | |
| Peak diameter of | (μm) | 0.30 | 0.30 | 0.30 | 0.30 |
| seed | | | | | |
| Amount of | (part) | 2 | 2 | 2 | 2 |
| charged seed | | | | | |
| Vinyl chloride | (part) | 100 | 100 | 100 | 100 |
| monomer | | | | | |
| Water | (part) | 150 | 150 | 150 | 150 |
| Ammonium | (part) | 0.02 | — | — | — |
| polyoxyethylene | | | | | |
| dinonylphenyl | | | | | |
| ether sulfate | | | | | |
| Ammonium | (part) | — | 0.02 | — | — |
| polyoxyethylene | | | | | |
| lauryl ether | | | | | |
| sulfate | | | | | |
| Ammonium | (part) | — | — | 0.02 | — |
| polyoxyethylene | | | | | |
| lauryl ether | | | | | |
| acetate | | | | | |
| Sodium laurate | (part) | — | — | — | 0.02 |
| Sodium sulfite | (part) | 0.03 | 0.03 | 0.03 | 0.03 |
| Copper sulfate | (part) | 0.0003 | 0.0003 | 0.0003 | 0.0003 |
| Continuous | | | | | |
| addition | | | | | |
| Ammonium | (part) | 0.01 | 0.01 | 0.01 | 0.01 |
| persulfate | | | | | |
| Ammonium | (part) | 0.48 | — | — | — |
| polyoxyethylene | | | | | |
| dinonylphenyl | | | | | |
| ether sulfate | | | | | |
| Ammonium | (part) | — | 0.48 | — | — |
| polyoxyethylene | | | | | |
| lauryl ether | | | | | |
| acetate | | | | | |
| Ammonium | (part) | — | — | 0.48 | — |
| polyoxyethylene | | | | | |
| lauryl ether | | | | | |
| acetate | | | | | |
| Sodium laurate | (part) | — | — | — | 0.48 |
| Polymerization | (° C.) | 50 | 50 | 50 | 50 |
| temperature | | | | | |
| Polymerization | (%) | 92 | 89 | 90 | 91 |
| conversion | | | | | |
| (A) Less than 0.5 | (%) | 23 | 22 | 28 | 25 |
| μm | | | | | |
| (B) At least 0.5 | (%) | 77 | 78 | 72 | 75 |
| μm | | | | | |
| Peak diameter of | (μm) | 0.33 | 0.30 | 0.31 | 0.33 |
| (A) | | | | | |
| Peak diameter of | (μm) | 0.73 | 0.72 | 0.68 | 0.70 |
| (B) | | | | | |

### Example 1

The latex prepared in Preparation Example 1 and the latex prepared in Preparation Example 5 were mixed in a weight ratio of 80:20 to obtain a latex. The thus-obtained latex was spray-dried by using a spray dryer (made by Mitsubishi Kakoki Kaisha) at an inhalation port temperature of 135° C. and a discharge port temperature of 52° C. The resin after spray drying was pulverized in an amount of 1 kg by using Bantam mill (type AP-B made by Hosokawa Micron Corporation) to determine recovery percentage of the resin. Specific surface area, viscosity, clarity and heat resistance of the resin were evaluated and judged. The results are shown in Table 5.

### Comparative Example 1

The latex obtained in Preparation Example 1 was spray-dried and the same evaluation and judgment as that of Example 1 were carried out. The results are shown in Table 5.

### Comparative Examples 2 to 3

A latex was obtained in the same manner as in Example 1 except for changing the latex prepared in Preparation Example 1 to the latex prepared in Preparation Example 2 or 3. The thus obtained latex was spray-dried and the same evaluation and judgment as that of Example 1 were carried out. The results are shown in Table 5.

TABLE 5

| | | | Com. | Com. | Com. |
|---|---|---|---|---|---|
| | | Ex. 1 | Ex. 1 | Ex. 2 | Ex. 3 |
| Preparation Example 1 | (part) | 80 | 100 | — | — |
| (ammonium laurate) | | | | | |
| Preparation Example 2 | (part) | — | — | 80 | — |
| (sodium lauryl sulfate) | | | | | |
| Preparation Example 3 | (part) | | | | 80 |
| (ammonium laurate) | | | | | |
| Preparation Example 5 | (part) | 20 | — | 20 | 20 |
| (ammonium polyoxy- | | | | | |
| ethylene dinonyl- | | | | | |
| phenyl ether sulfate) | | | | | |
| Peak diameter of (A) | (μm) | 0.35 | — | 0.35 | 0.35 |
| Peak diameter of (B) | (μm) | 0.85 | 0.85 | 0.90 | 1.40 |
| Specific surface area | (m²/g) | 7.1 | 4.7 | 7.0 | 5.4 |
| Recovery percentage | (%) | 83 | 82 | 88 | 82 |
| after pulverization | | | | | |
| Plastisol viscosity | (mPa · s) | 4500 | 3100 | 7000 | 2800 |
| Haze 215° C. × 3 | | 2.0 | 4.8 | 4.0 | 5.2 |
| minute | | | | | |
| Evaluation of clarity | | ∘ | x | x | x |
| b value of color | | | | | |
| 215° C. × 3 minute | | 1.0 | 1.0 | 1.3 | 1.0 |
| b value of color | | | | | |
| 215° C. × 8 minute | | 2.9 | 3.0 | 6.2 | 2.7 |
| Time for blackening | (minute) | 22 | 22 | 18 | 22 |
| Evaluation of heat- | | ∘ | ∘ | x | ∘ |
| resistance | | | | | |

### Examples 2 to 4 and Comparative Example 4

Each latex obtained in Preparation Examples 8, 9, 10 and 11 was spray-dried and the same evaluation and judgment as that of Example 1 were carried out. The results are shown in Table 6.

TABLE 6

| | | | | | Com. |
|---|---|---|---|---|---|
| | | Ex. 2 | Ex. 3 | Ex. 4 | Ex. 4 |
| Preparation Example 8 | (part) | 100 | — | — | |
| (ammonium myristate) | | | | | |
| Preparation Example 9 | (part) | — | 100 | — | — |
| (ammonium myristate) | | | | | |
| Preparation Example | (part) | — | — | 100 | — |
| 10 (ammonium | | | | | |
| myristate) | | | | | |
| Preparation Example | (part) | — | — | — | 100 |
| 11 (ammonium | | | | | |
| myristate) | | | | | |
| Peak diameter of (A) | (μm) | 0.30 | 0.32 | 0.30 | 0.35 |
| Peak diameter of (B) | (μm) | 0.70 | 0.88 | 1.10 | 1.50 |
| Specific surface area | (m²/g) | 6.7 | 7.2 | 7.6 | 7.0 |
| Recovery percentage | (%) | 82 | 80 | 82 | 81 |
| after pulverization | | | | | |
| Plastisol viscosity | (mPa · s) | 4800 | 4600 | 5000 | 4200 |
| Haze 215° C. × 3 | | 1.0 | 2.2 | 2.9 | 5.0 |
| minute | | | | | |
| Evaluation of clarity | | ∘ | ∘ | ∘ | x |
| b value of color | | 1.2 | 1.0 | 1.1 | 0.9 |
| 215° C. × 3 minute | | | | | |
| b value of color | | 2.8 | 2.6 | 3.0 | 3.2 |
| 215° C. × 8 minute | | | | | |
| Time for blackening | (minute) | 22 | 22 | 22 | 22 |
| Evaluation of heat- | | ∘ | ∘ | ∘ | ∘ |
| resistance | | | | | |

### Examples 5 to 7 and Comparative Example 5

Each latex obtained in Preparation Examples 12, 13, 14 and 15 was spray-dried and the same evaluation and judgment as that of Example 1 were carried out. The results are shown in Table 7.

TABLE 7

| | | | | | Com. |
|---|---|---|---|---|---|
| | | Ex. 5 | Ex. 6 | Ex. 7 | Ex. 5 |
| Preparation Example | (part) | 100 | — | — | — |
| 12 (ammonium poly- | | | | | |
| oxyethylene dinonyl- | | | | | |
| phenyl ether sulfate) | | | | | |
| Preparation Example | (part) | — | 100 | — | — |
| 13 (ammonium poly- | | | | | |
| oxyethylene lauryl | | | | | |
| ether sulfate) | | | | | |
| Preparation Example | (part) | — | — | 100 | — |
| 14 (ammonium poly- | | | | | |
| oxyethylene lauryl | | | | | |
| ether acetate) | | | | | |
| Preparation Example | (part) | — | — | — | 100 |
| 15 (sodium laurate) | | | | | |
| Peak diameter of (A) | (μm) | 0.33 | 0.30 | 0.31 | 0.33 |
| Peak diameter of (B) | (μm) | 0.73 | 0.72 | 0.68 | 0.70 |
| Specific surface area | (m²/g) | 6.8 | 7.0 | 8.0 | 7.2 |
| Recovery percentage | (%) | 87 | 87 | 85 | 89 |
| after pulverization | | | | | |
| Plastisol viscosity | (mPa · s) | 3800 | 4100 | 5000 | 8000 |
| haze 215° C. × 3 | | 0.8 | 1.1 | 1.0 | 3.5 |
| minute | | | | | |
| Evaluation of clarity | | ∘ | ∘ | ∘ | x |
| b value of color | | 1.1 | 0.9 | 1.2 | 1.5 |
| 215° C. × 3 minute | | | | | |
| b value of color | | 3.0 | 3.2 | 3.3 | 9.8 |
| 215° C. × 8 minute | | | | | |
| Time for blackening | (minute) | 22 | 22 | 22 | 24 |
| Evaluation of heat- | | ∘ | ∘ | ∘ | x |
| resistance | | | | | |

### Comparative Example 6

To the latex obtained in Preparation Example 9 was added 0.05 part of sodium hydroxide based on 100 parts of a vinyl chloride monomer, and spray drying was conducted. The same evaluation and judgment as that of Example 1 were carried out. The results are shown in Table 8.

### Comparative Example 7

To the latex obtained in Preparation Example 9 was added 0.3 part of sodium di-2-ethylhexylsulfosuccinate (trade name: Rapisol A-80 available from NOF Corporation) as purity content based on 100 parts of a vinyl chloride monomer, and spray drying was conducted. The same evaluation and judgment as that of Example 1 were carried out. The results are shown in Table 8.

### Comparative Example 8

To the latex obtained in Preparation Example 9 was added 0.3 part of sodium lauryl sulfate based on 100 parts of a vinyl chloride monomer, and spray-drying was conducted. The same evaluation and judgment as that of Example 1 were carried out. The results are shown in Table 8.

### Comparative Example 9

To the latex obtained in Preparation Example 9 was added 0.3 part of modified aliphatic dimethylethyl ammonium ethosulfate (trade name: Elegane 264-WAX available from NOF Corporation) which is an effective antistatic agent as purity content based on 100 parts of a vinyl chloride monomer, and spray-drying was conducted. The same evaluation and judgment as that of Example 1 were carried out. The results are shown in Table 8.

### Example 8

To the latex prepared in Preparation Example 9 was added 0.3 part of an ester-type ammonium salt of a copolymer comprising styrene and maleic anhydride in a ratio of 1/1 (trade name: SMA1440H available from Elf Atochem Co., Ltd.) as purity content based on 100 parts of a vinyl chloride monomer. Then, spray drying was conducted and the same evaluation and judgment as that of Example 1 were carried out. The results are shown in Table 8.

TABLE 8

| | | Com. | Com. | Com. | Com. | |
|---|---|---|---|---|---|---|
| | | Ex. 6 | Ex. 7 | Ex. 8 | Ex. 9 | Ex. 8 |
| Preparation Example 9 | (part) | 100 | 100 | 100 | 100 | 100 |
| (ammonium myristate) | | | | | | |
| Sodium hydroxide | (actual part) | 0.05 | — | — | — | — |
| Rapisol A-80 | (actual part) | — | 0.3 | — | — | — |
| Sodium lauryl sulfate | (actual part) | — | — | 0.3 | — | — |
| Elegane 264-WAX | (actual part) | — | — | — | 0.3 | — |
| SMA1440H | (actual part) | — | — | — | — | 0.3 |
| Recovery percentage after | (%) | 83 | 87 | 88 | 92 | 97 |
| pulverization | | | | | | |
| Plastisol viscosity | (mPa · s) | 7000 | 7200 | 5600 | 4800 | 4500 |
| Haze 215° C. × 3 minute | | 3.6 | 1.8 | 3.2 | 2.4 | 0.8 |
| Evaluation of clarity | | x | ∘ | x | ∘ | ∘ |
| b value of color | | 1.2 | 1.0 | 1.0 | 3.0 | 1.1 |
| 215° C. × 3 minute | | | | | | |
| b value of color | | 12.0 | 8.4 | 5.2 | 43.1 | 3.6 |
| 215° C. × 8 minute | | | | | #1 | |
| Time for blackening | (minute) | 22 | 18 | 20 | 8 | 22 |
| Evaluation of heat-resistance | | x | x | x | x | ∘ |

#1: Data at 215° C. for 6 minutes, completely blackened at 215° C. for 8 minutes.

### Examples 9 to 10

To the latex prepared in Preparation Example 9 was added 0.02 part (EXAMPLE 9) or 0.2 part (EXAMPLE 10) as purity contents of a sodium salt of a copolymer comprising styrene and maleic anhydride in a ratio of 1/1 (trade name: SMA1000H, available from Elf Atochem Co., Ltd.) based on 100 parts of a vinyl chloride monomer. Then spray-drying was conducted and the same evaluation and judgment as that of Example 1 were carried out. The results are shown in Table 9.

### Example 11 and 12

To the latex prepared in Preparation Example 9 was added 0.05 part (EXMAPLE 11) or 0.2 part (EXAMPLE 12) of SMA1440H as purity contents based on 100 parts of a vinyl chloride monomer, and spray drying was conducted. The same evaluation and judgment as that of Example 1 were carried out. The results are shown in Table 9.

### Example 13

To the latex prepared in Preparation Example 9 was added 0.05 part of a sodium salt of a copolymer comprising styrene and maleic anhydride in a ratio of 3/1 (trade name: SMA3000H available from Elf Atochem Co., Ltd.) as purity content based on 100 parts of a vinyl chloride monomer. Then, spray drying was conducted and the same evaluation and judgment as that of Example 1 were carried out. The results are shown in Table 9.

TABLE 9

| | | Ex. 9 | Ex. 10 | Ex. 11 | Ex. 12 | Ex. 13 |
|---|---|---|---|---|---|---|
| Preparation Example 9 | (part) | 100 | 100 | 100 | 100 | 100 |
| (ammonium myristate) | | | | | | |
| SMA1000H | (actual part) | 0.02 | 0.2 | — | — | — |
| SMA1440H | (actual part) | — | — | 0.05 | 0.2 | — |
| SMA3000H | (actual part) | — | — | — | — | 0.05 |
| Recovery percentage after | (%) | 90 | 95 | 93 | 96 | 93 |
| pulverization | | | | | | |
| Plastisol viscosity | (mPa · s) | 4400 | 4600 | 4500 | 4500 | 5000 |
| Haze 215° C. × 3 minute | | 1.9 | 1.2 | 1.6 | 1.0 | 1.5 |
| Evaluation of clarity | | ∘ | ∘ | ∘ | ∘ | ∘ |
| b value of color | | 1.1 | 1.1 | 1.1 | 1.1 | 1.0 |
| 215° C. × 3 minute | | | | | | |
| b value of color | | 2.7 | 3.8 | 2.8 | 3.3 | 2.9 |
| 215° C. × 8 minute | | | | | | |
| Time for blackening | (minute) | 22 | 22 | 22 | 22 | 22 |
| Evaluation of heat-resistance | | ∘ | ∘ | ∘ | ∘ | ∘ |

### Example 14

To the latex prepared in Preparation Example 9 was added 0.05 part of a sodium salt of a copolymer comprising maleic anhydride and diisobutylene in a ratio of 1/1 (trade name: Polystar OM available from NOF Corporation) as purity content based on 100 parts of a vinyl chloride monomer. Then, spray drying was conducted and the same evaluation and judgment as that of Example 1 were carried out. The results are shown in Table 10.

### Example 15

To the latex prepared in Preparation Example 9 was added 0.05 part of a sodium salt of a copolymer comprising maleic anhydride and diisobutylene in a ratio of 1/1 (trade name: Polystar OMA available from NOF Corporation) as purity content based on 100 parts of a vinyl chloride monomer. Then, spray drying was conducted and the same evaluation and judgment as that of Example 1 were carried out. The results are shown in Table 10.

### Example 16

To the latex prepared in Preparation Example 9 was added 0.05 part of a copolymer having a polyoxylene alkylene group and comprising maleic anhydride and styrene (trade name: Malialim HKM-50A available from NOF Corporation) as purity content based on 100 parts of a vinyl chloride monomer. Then, spray drying was conducted and the same evaluation and judgment as that of Example 1 were carried out. The results are shown in Table 10.

### Example 17

To the latex prepared in Preparation Example 9 was added 0.05 part of a copolymer of methoxyethylene maleic anhydride (trade name: GANTREZ AN-139 available from Gokyo Sangyo Co., Ltd.) as purity content based on 100 parts of a vinyl chloride monomer. Then, spray drying was conducted and the same evaluation and judgment as that of Example 1 were carried out. The results are shown in Table 10.

### Example 18

To the latex prepared in Preparation Example 9 was added 0.05 part of hydroxypropylmethyl cellulose (trade name: Metlose 60SH-50 available from Shin-Etsu Chemical Co., Ltd.) as purity content based on 100 parts of a vinyl chloride monomer. Then, spray drying was conducted and the same evaluation and judgment as that of Example 1 were carried out. The results are shown in Table 10.

TABLE 10

| | | Ex. 14 | Ex. 15 | Ex. 16 | Ex. 17 | Ex. 18 |
|---|---|---|---|---|---|---|
| Preparation Example 9 | (part) | 100 | 100 | 100 | 100 | 100 |
| (ammonium myristate) | | | | | | |
| Polystar OM | (actual part) | 0.05 | — | — | — | — |
| Polystar OMA | (actual part) | — | 0.05 | — | — | — |
| Malialim HKM-50A | (actual part) | — | — | 0.05 | — | — |
| GANTREZ AN-139 | (actual part) | — | — | — | 0.05 | — |
| Metlose 60SH-50 | (actual part) | — | — | — | — | 0.05 |
| Recovery percentage after | (%) | 92 | 94 | 93 | 93 | 92 |
| pulverization | | | | | | |
| Plastisol viscosity | (mPa · s) | 5000 | 5100 | 4600 | 4700 | 4800 |
| haze 215° C. × 3 minute | | 1.6 | 1.5 | 1.6 | 1.7 | 2.2 |
| Evaluation of clarity | | ∘ | ∘ | ∘ | ∘ | ∘ |
| b value of color | | 1.0 | 1.0 | 1.1 | 1.1 | 1.0 |
| 215° C. × 3 minute | | | | | | |
| b value of color | | 3.0 | 3.2 | 3.2 | 3.1 | 2.8 |
| 215° C. × 8 minute | | | | | | |
| Time for blackening | (minute) | 22 | 22 | 22 | 22 | 22 |
| Evaluation of heat-resistance | | ∘ | ∘ | ∘ | ∘ | |

### Examples 19 to 20

To the latex prepared in Preparation Example 9 was added 0.05 part of partially saponified poly(vinyl alcohol) (trade name: Gohsenol GM-14 available from The Nippon Synthetic Chemical Industry Co. Ltd.) (EXAMPLE 19) or 0.1 part thereof (EXAMPLE 20) as purity contents based on 100 parts of a vinyl chloride monomer. Then, spray drying was conducted, and the same evaluation and judgment as that of Example 1 were carried out. The results are shown in Table 11.

### Examples 21 to 22

To the latex prepared in Preparation Example 9 was added 0.05 part of partially saponified poly(vinyl alcohol) (trade name: Kuraray poval PVA-217 available from Kuraray Co. Ltd.) (EXAMPLE 21) or 0.1 part thereof (EXAMPLE 22) based on 100 parts of a vinyl chloride monomer. Then, spray drying was conducted and the same evaluation and judgment as that of Example 1 were carried out. The results are shown in Table 11.

### Example 23

To the latex prepared in Preparation Example 13 was added 0. 1 part of Kuraray poval PVA-217 as purity content based on 100 parts of a vinyl chloride monomer. Then, spray drying was conducted and the same evaluation and judgment as that of Example 1 were carried out. The results are shown in Table 11.

TABLE 11

| | | Ex. 19 | Ex. 20 | Ex. 21 | Ex. 22 | Ex. 23 |
|---|---|---|---|---|---|---|
| Preparation Example 9 | (part) | 100 | 100 | 100 | 100 | — |
| (ammonium myristate) | | | | | | |
| Preparation Example 13 | (part) | — | — | — | — | 100 |
| (ammonium polyoxyethylene | | | | | | |
| lauryl ether sulfate) | | | | | | |
| Gohsenol GM-14 | (actual part) | 0.05 | 0.1 | — | — | — |
| PVA-217 | (actual part) | — | — | 0.05 | 0.1 | 0.1 |
| Recovery percentage after | (%) | 93 | 96 | 92 | 95 | 94 |
| pulverization | | | | | | |
| Plastisol viscosity | (mPa · s) | 4600 | 4600 | 4500 | 4800 | 4300 |
| Haze 215° C. × 3 minute | | 2.2 | 2.3 | 2.3 | 2.3 | 1.1 |
| Evaluation of clarity | | ∘ | ∘ | ∘ | ∘ | ∘ |
| b value of color | | 1.1 | 1.1 | 0.9 | 0.9 | 1.0 |
| 215° C. × 3 minute | | | | | | |
| b value of color | | 2.7 | 3.1 | 2.6 | 2.9 | 3.4 |
| 215° C. × 8 minute | | | | | | |
| Time for blackening | (minute) | 22 | 22 | 22 | 22 | 22 |
| Evaluation of heat-resistance | | ∘ | ∘ | ∘ | ∘ | ∘ |

### Example 24

The latex prepared in Preparation Example 1 and the latex prepared in Preparation Example 5 were mixed in a weight ratio of 80:20 to obtain a latex. To the thus-obtained latex was added 0.05 part of SMA1000H as purity content based on 100 parts of a vinyl chloride monomer, and spray drying was conducted. The same evaluation and judgment as that of Example 1 were carried out. The results are shown in Table 12.

### Examples 25 to 27

To each latex obtained in Preparation Examples 12, 13 and 14 was added 0.05 part of SMA1000H as purity content based on 100 parts of a vinyl chloride monomer, and spray drying was conducted. The same evaluation and judgment as that of Example 1 were carried out. The results are shown in Table 12.

TABLE 12

| | | Ex. 24 | Ex. 25 | Ex. 26 | Ex. 27 |
|---|---|---|---|---|---|
| Preparation Example 1 | (part) | 80 | − | − | − |
| (ammonium laurate) | | | | | |
| Preparation Example 5 | (part) | 20 | − | − | − |
| (ammonium | | | | | |
| polyoxyethylene | | | | | |
| dinonylphenyl ether | | | | | |
| sulfate) | | | | | |
| Preparation | (part) | − | 100 | − | − |
| Example 12 | | | | | |
| (ammonium | | | | | |
| polyoxyethylene | | | | | |
| dinonylphenyl ether | | | | | |
| sulfate) | | | | | |
| Preparation | (part) | − | − | 100 | − |
| Example 13 | | | | | |
| (ammonium | | | | | |
| polyoxyethylene | | | | | |
| lauryl ether | | | | | |
| sulfate) | | | | | |
| Preparation | (part) | − | − | − | 100 |
| Example 14 | | | | | |
| (ammonium | | | | | |
| polyoxyethylene | | | | | |
| lauryl ether | | | | | |
| acetate) | | | | | |
| SMA1000H | (actual | 0.05 | 0.05 | 0.05 | 0.05 |
| | part) | | | | |
| Recovery percentage | (%) | 93 | 95 | 96 | 95 |
| after | | | | | |
| pulverization | | | | | |
| Plastisol viscosity | (mP·s) | 4600 | 3900 | 4000 | 5100 |
| Haze 215° C. × 3 | | 1.6 | 0.5 | 0.7 | 0.6 |
| minute | | | | | |
| Evaluation of clarity | | ◯ | ◯ | ◯ | ◯ |
| b value of color | | 1.0 | 1.1 | 0.9 | 1.3 |
| 215° C. × 3 | | | | | |
| minute | | | | | |
| b value of color | | 3.1 | 3.3 | 3.5 | 3.5 |
| 215° C. × 8 | | | | | |
| minute | | | | | |
| Time for blackening | (minute) | 22 | 22 | 22 | 22 |
| Evaluation of | | ◯ | ◯ | ◯ | ◯ |
| heat-resistance | | | | | |

According to the polyvinyl chloride dispersion resin of the present invention in which a particular ammonium salt emulsifier is used and whose specific surface area and particle diameter distribution are adjusted to particular ranges, a product excellent in clarity and heat resistance can be obtained. Further, by adding a polymeric suspending agent, pulverization efficiency is improved and recovery percentage of the resin is increased.

The polyvinyl chloride dispersion resin of the present invention comprises a latex containing 0.1 to 5 parts by weight of an ammonium salt emulsifier based on 100 parts by weight of a vinyl chloride monomer, wherein the polyvinyl chloride dispersion resin has a specific surface area of 5 to 10 m²/g and comprises (A) 10 to 60% by weight of a particle having a particle diameter distribution of less than 0.5 μm and having at least one peak diameter of the distribution in the range of at least 0.1 μm to less than 0.5 μm and (B) 40 to 90% by weight of a particle having a particle diameter distribution of at least 0.5 μm and having at least one peak diameter of the distribution in the range of at least 0.5 μm to at most 1.3 μm. According to this, it is possible to obtain a polyvinyl chloride dispersion resin, a plastisol composition and a plastigel composition from which a product having excellent clarity and heat resistance can be prepared.

What is claimed is:

1. A polyvinyl chloride dispersion resin which is obtained by polymerization using 0.1 to 5.0 parts by weight of at least one ammonium salt emulsifier selected from the group consisting of an ammonium carboxylate salt emulsifier, an ammonium sulfate salt emulsifier and an ammonium sulfonate salt emulsifier, based on 100 parts by weight of a vinyl chloride monomer, wherein the polyvinyl chloride dispersion resin has a specific surface area of 5 to 10 m²/g and comprises
(A) 10 to 60% by weight of a particle having a particle diameter distribution of less than 0.5 μm and having at least one peak diameter of the distribution in the range of at least 0.1 μm to less than 0.5 μm and
(B) 40 to 90% by weight of a particle having a particle diameter distribution of at least 0.5 μm and having at least one peak diameter of the distribution in the range of at least 0.5 μm to at most 1.3 μm.

2. The polyvinyl chloride dispersion resin of claim 1, wherein the particle (B) has a peak diameter of the distribution of at least 0.6 μm to at most 0.9 lm.

3. The polyvinyl chloride dispersion resin of claim 1, wherein the particle (A) has a peak diameter of the distribution of at least 0.2 μm to at most 0.4 μm.

4. The polyvinyl chloride dispersion resin of claim 1, wherein the amount of the component (A) is 20% by weight to 50% by weight and the amount of the component (B) is 80 to 50% by weight.

5. The polyvinyl chloride dispersion resin of claim 1, wherein seed emulsion polymerization is carried out as polymerization.

6. The polyvinyl chloride dispersion resin of claim 1, wherein fatty acid ammonium having 10 to 20 carbon atoms is used as the ammonium salt emulsifier.

7. The polyvinyl chloride dispersion resin of claim 1, wherein the ammonium emulsifier is at least one selected from the group consisting of a compound represented by the formula (I):
R¹O(CH₂CH₂O)ₙR²COONH₄ (I)
wherein R¹ is a monovalent hydrocarbon group having 8 to 30 carbon atoms, R² is a divalent hydrocarbon group having 1 to 30 carbon atoms and n is an integer of 1 to 30 and a compound represented by the formula (II): 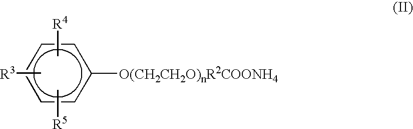
wherein each of R³, R⁴ and R⁵ is a hydrogen atom or a monovalent hydrocarbon group having 1 to 30 carbon atoms, R² is a divalent hydrocarbon group having 1 to 30 carbon atoms and n is an integer of 1 to 30.

8. The polyvinyl chloride dispersion resin of claim 1, wherein the ammonium emulsifier is at least one selected from the group consisting of a compound represented by the formula (III):
R¹O(CH₂CH₂O)ₙSO₃NH₄ (III)
wherein R¹ is a monovalent hydrocarbon group having 8 to 30 carbon atoms and n is an integer of 1 to 30 and a compound represented by the formula (IV): 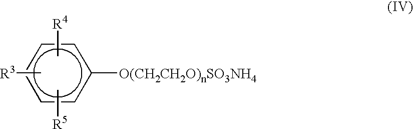
wherein each of R³, R⁴ and R⁵ is a hydrogen atom or a monovalent hydrocarbon group having 1 to 30 carbon atoms and n is an integer of 1 to 30.

9. The polyvinyl chloride dispersion resin of claim 1, wherein the polyvinyl chloride dispersion resin is obtained by polymerization further using 0.005 to 1.0 part by weight of a polymeric suspending agent based on 100 parts by weight of the vinyl chloride monomer.

10. The polyvinyl chloride dispersion resin of claim 1, which is obtained by adding the polymeric suspending agent to a latex of the polyvinyl chloride dispersion resin after polymerization.

11. The polyvinyl chloride dispersion resin of claim 9, wherein the polymeric suspending agent is at least one selected from the group consisting of a vinyl polymer, a vinyl copolymer and an ammonium salt thereof.

12. The polyvinyl chloride dispersion resin of claim 9, wherein the polymeric suspending agent is poly(vinyl alcohol).

13. The polyvinyl chloride dispersion resin of claim 9, wherein the polymeric suspending agent is a cellulose derivative.

14. The polyvinyl chloride dispersion resin of claim 9, wherein the polymeric suspending agent is at least one selected from the group consisting of a carboxylic acid polymer, a carboxylic acid copolymer and an ammonium salt thereof.

15. The polyvinyl chloride dispersion resin of claim 9, wherein the polymeric suspending agent is at least one selected from the group consisting of maleic anhydride polymer, maleic anhydride copolymer and an ammonium salt thereof.

16. The polyvinyl chloride dispersion resin of claim 9, wherein the polymeric suspending agent is at least one selected from the group consisting of a copolymer comprising maleic anhydride and styrene, and an ammonium salt thereof.

17. The polyvinyl chloride dispersion resin of claim 9, wherein the polymeric suspending agent is at least one selected from the group consisting of a sodium salt and potassium salt of a vinyl polymer, a vinyl copolymer, a carboxylic acid polymer, a carboxylic acid copolymer, a maleic anhydride polymer, a maleic anhydride copolymer and a copolymer comprising maleic anhydride and styrene, and wherein the amount of the polymeric suspending agent is 0.005 to 0.3 part by weight based on 100 parts by weight of a vinyl chloride monomer.

18. A plastisol composition comprising the polyvinyl chloride dispersion resin of claim 1.

19. A plastigel composition comprising the polyvinyl chloride dispersion resin of claim 1.
